(19) United States
(12) Patent Application Publication
(10) Pub. No.: US 2020/0401942 A1
(43) Pub. Date: Dec. 24, 2020

(54) ASSOCIATED INFORMATION IMPROVEMENT DEVICE, ASSOCIATED INFORMATION IMPROVEMENT METHOD, AND RECORDING MEDIUM IN WHICH ASSOCIATED INFORMATION IMPROVEMENT PROGRAM IS RECORDED

(71) Applicant: NEC CORPORATION, Tokyo (JP)

(72) Inventors: Takuya HIRAOKA, Tokyo (JP); Takashi ONISHI, Tokyo (JP)

(73) Assignee: NEC CORPORATION, Tokyo (JP)

(21) Appl. No.: 16/968,403

(22) PCT Filed: Feb. 9, 2018
(86) PCT No.: PCT/JP2018/004655

§ 371 Date: Aug. 7, 2020

(51) Int. Cl. G06N 20/00

(52) U.S. Cl. CPC G06N 20/00

(57) ABSTRACT

Provided is an associated information improvement device that improves associated information. The associated information improvement device is provided with: a selection means for selecting, on the basis of priority information in which associated information having two out of a plurality of states relating to a target system associated therewith and numeric information relating to this associated information are associated, associated information in which the numeric information satisfies a first prescribed condition; a specification means for preparing a path including an intermediate state from some state to a goal state on the basis of the selected associated information, and specifying a reward given to a state included in the path; and a calculation means for calculating numeric information for the case in which the specified reward and a difference between the numeric information and prescribed numeric information relating to the numeric information satisfy a second prescribed condition.

### TECHNICAL FIELD

The present invention relates to an associated information improvement device and, more particularly, to an associated information improvement device in a hierarchical planner.

### BACKGROUND ART

Reinforcement Learning is a kind of machine learning and deals with a problem in which an agent in an environment observes a current state and determines actions to be carried out. The agent gets a reward from the environment by selecting the actions. The reinforcement learning learns a policy such that the maximum reward is obtained through a series of actions. The environment is also called a controlled target or a target system.

In the reinforcement learning in a complicated environment, a huge amount of calculation time required in learning tends to become a large bottleneck. As one of variations of the reinforcement learning for resolving such a problem, there is a framework called a “Hierarchical Reinforcement Learning” in which the learning is improved in efficiency by preliminarily limiting, using a different model, a range to be searched and by performing the learning in such limited search space by a reinforcement learning agent. The model for limiting the search space is called a high-level planner whereas a reinforcement learning model for performing the learning in the search space presented by the high-level planner is called a low-level planner. A combination of the high-level planner and the low-level planner is called a hierarchical planner. A combination of the low-level planner and the environment is also called a simulator.

For example, Non-Patent Literature 1 proposes a hierarchical planner including a high-level planner for carrying out an operation based on prior knowledge and hierarchical planner parameters, and a framework for optimization thereof. The prior knowledge is also called associated information.

### CITATION LIST

### Non-Patent Literatures

NPL 1: Branavan, S. R. K., et al. “Learning high-level planning from text.” Proceedings of the 50th Annual Meeting of the Association for Computational Linguistics: Long Papers-Volume 1. Association for Computational Linguistics, 2012.
NPL 2: Williams, Ronald J. “Simple statistical gradient-following algorithms for connectionist reinforcement learning.” Machine learning 8.3-4 (1992):229-256.

### SUMMARY OF THE INVENTION

### Technical Problem

The prior knowledge indicates accumulation of formalized human knowledge, for example, an operation manual of a plant and so on. In a hierarchical planner optimization device disclosed in Non-Patent Literature 1, the prior knowledge (associated information) is dealt with as a static one and is not updated in hierarchical planner optimization. Therefore, even if the prior knowledge (associated information) is incorrect and/or has omissions, it is impossible to improve it. In general, it is often difficult for human being to construct such prior knowledge (associated information) without errors and comprehensively. Accordingly, it would be useful to be able to semi-automatically improve the prior knowledge (associated information) constructed by human being.

### OBJECT OF INVENTION

It is an object of the present invention to provide an associated information improvement device which is capable of resolving the above-mentioned problem.

### Solution to Problem

As an aspect of the present invention, an associated information improvement device comprises a selection means configured to select, based on priority information in which associated information and numeric information relating to the associated information are associated with each other, associated information associated with the numeric information which satisfies a first predetermined condition, the associated information being information in which two states among a plurality of states related to a target system are associated with each other, a specification means configured to prepare a path including an intermediate state from a certain state to a goal state based on the selected associated information and to specify a reward given to a state included in the path; and a calculation means configured to calculate the numeric information in a case where the specified reward and a difference between the numeric information and given numeric information relating to the numeric information satisfy a second predetermined condition.

### Advantageous Effects of Invention

According to the present invention, it is possible to carry out improvement of associated information based on optimization of numeric information.

### BRIEF DESCRIPTION OF THE DRAWINGS

FIG. 1 is a block diagram for illustrating a configuration of a control system which includes a hierarchical planner in a related art and which is prepared by the present inventors by interpreting a method proposed in Non-Patent Literature 1;

FIG. 2 is a block diagram for illustrating an internal configuration of a high-level planner for use in the hierarchical planner of FIG. 1;

FIG. 3 is a block diagram for illustrating an internal configuration of a low-level planner for use in the hierarchical planner of FIG. 1;

FIG. 4 is a block diagram for illustrating a configuration of a control system including a hierarchical planner according to an example embodiment of the present invention;

FIG. 5 is a block diagram for illustrating an internal configuration of a high-level planner for use in the hierarchical planner of FIG. 4;

FIG. 6 is a flow chart for use in describing an operation of the hierarchical planner according to the example embodiment of the present invention;

FIG. 7 is a view for illustrating a Mountain Car task which is used in an example of the present invention;

FIG. 8 is a view for illustrating an example of a Step S101 in FIG. 6;

FIG. 9 is a view for illustrating an example of a Step S102 in FIG. 6;

FIG. 10 is a view for illustrating an example of a Step S103 in FIG. 6; and

FIG. 11 is a view for illustrating an example of a Step S105 in FIG. 6.

### DESCRIPTION OF EMBODIMENTS

### Related Art

In order to facilitate an understanding of the present invention, a related art will be described first.

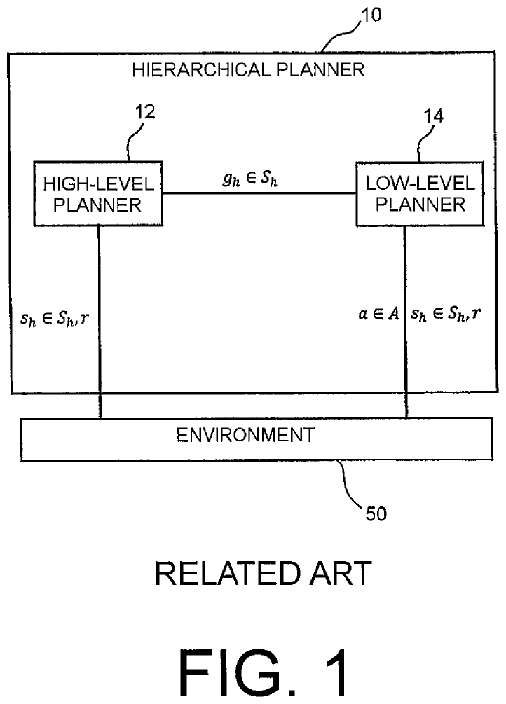

FIG. 1 is a block diagram for illustrating a configuration of a control system including a hierarchical planner according to the related art proposed in Non-Patent Literature 1. As shown in FIG. 1, the control system proposed in Non-Patent Literature 1 comprises the hierarchical planner 10 and an environment 50. The environment 50 is also called a controlled target or a target system.

The hierarchical planner 10 comprises a high-level planner 12 and a low-level planner 14.

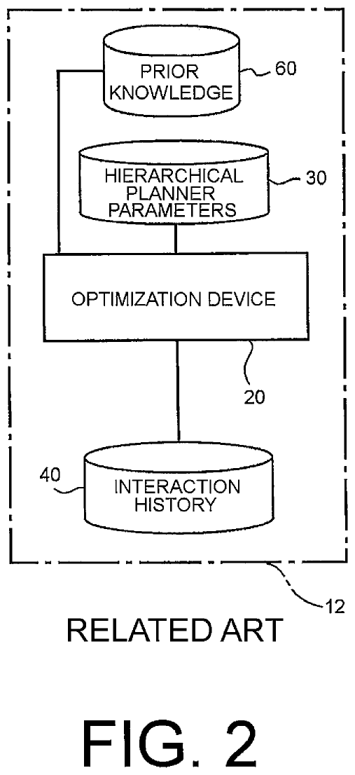

FIG. 2 is a block diagram for illustrating an internal configuration of the high-level planner 12 for use in the hierarchical planner 10 of FIG. 1. The high-level planner 12 comprises an optimization device 20, a parameter storage unit 30 for storing hierarchical planner parameters, a history recording medium 40 for recording an interaction history, and a knowledge recording medium 60 for recording prior knowledge. As described above, the prior knowledge is also called associated information. The optimization device 20 is also called a numeric information calculation circuitry.

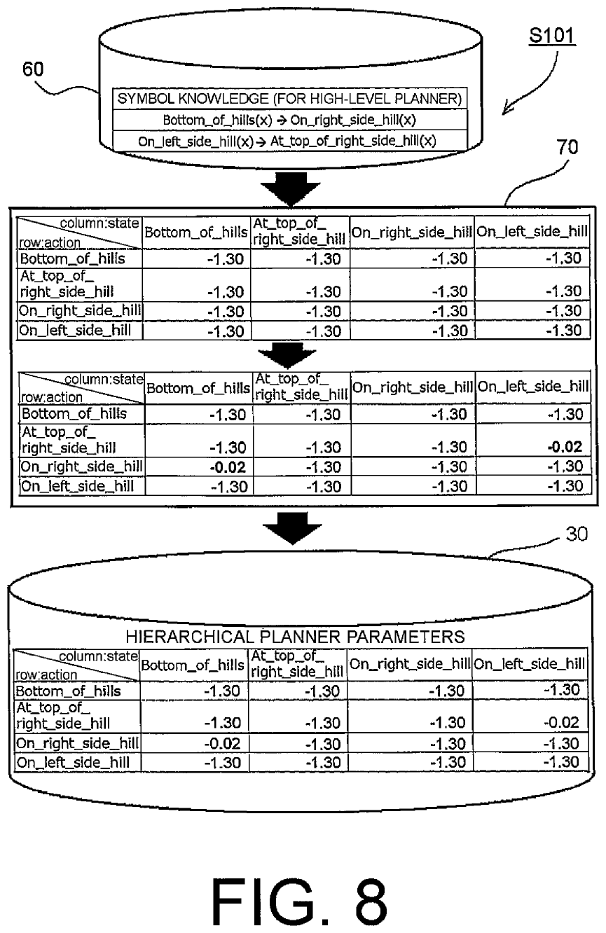

The knowledge recording medium 60 stores symbol knowledge (associated information), for example, as exemplified in FIG. 8. Each symbol knowledge stored in the knowledge recording medium 60 is associated with a weight a indicative of a degree of importance of the symbol. For instance, it is indicated that, as the weight a has a larger value, the knowledge holds true at a higher possibility. Conversely, it is indicated that, as the weight a has a smaller value, the knowledge holds true at a lower possibility.

The control system of the related art having such a configuration operates as follows.

The environment 50 receives an action a, and produces a state symbol sₕ belonging to a state symbol set Si and a reward r. Herein, the state symbol sₕ is a symbol represented by a symbolic representation in knowledge. Although not illustrated in the figure. the environment 50 includes a first conversion unit. The first conversion unit produces, based on a first symbol grounding function, the above-mentioned state symbol sₕ and the reward r from numeric state information s being a continuous quantity representing a state of the environment 50 with a numeric representation, the reward r, and first symbol grounding parameters. The first conversion unit 14 is also called a low-level/high-level conversion unit.

The high-level planner 12 receives the state symbol sₕ, the reward r, and high-level planner parameters, and produces a subgoal symbol gₕ belonging to the state symbol set Sₕ. Herein, the subgoal symbol gₕ is a symbol indicative of an intermediate state represented by the symbolic representation in the knowledge. In this specification, the subgoal symbol gₕ may simply be called an “intermediate state”. In addition, a starting state, a target state (goal state), and the intermediate state may simply be called “states” collectively.

The low-level planner 14 receives the state symbol sₕ, the subgoal symbol gₕ, and low-level planner parameters, and produces the action a belonging to an action set A. More in detail, the low-level planner 14 receives, from the environment 50. the numeric state information s belonging to the state set S and the reward r. Herein, the numeric state information s is a continuous quantity representing a state of the environment 50 with a numeric representation. The numeric state information s is observation information which is observed with respect to the environment (target system) 50.

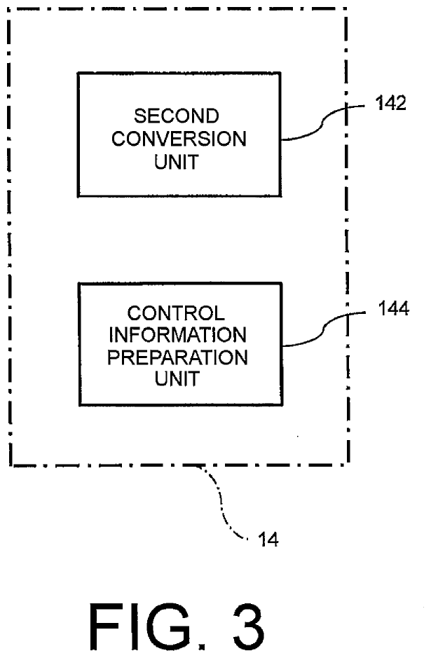

As shown in FIG. 3, the low-level planner 14 comprises a second conversion unit 142 and a control information preparation unit 144. The second conversion unit 142 receives the subgoal symbol gₕ and second symbol grounding parameters, and produces, based on a second symbol grounding function, a subgoal belonging to the state set S. Herein, the subgoal comprises numeric information indicative of the intermediate state. Hereinafter, the numeric information indicative of a certain state is represented by “numeric state information”. The second conversion unit 142 may be called a high-level/low-level conversion unit. The control information preparation unit 144 generates, based on a difference between the subgoal and the observation information, control information for controlling the environment (target system) 50 as the action a.

It is assumed that a series of these steps is one process. Then, the history recording medium 40 receives, for every one process, the state symbol s_{b}, the reward r, the subgoal symbol gₐ, and the action a, and records them as the interaction history.

The optimization device 20 receives, from the history recording medium 40, the state symbol sₕ, the reward r, the subgoal symbol gₕ, and the action a, which are saved as the interaction history, and updates parameters for the hierarchical planner 10 to produce updated parameters. The optimization device 20 updates parameters for the high-level planner 12 based on the interaction history to produce updated high-level planner parameters.

The parameter storage unit 30 receives the parameters from the optimization device 20, saves them as hierarchical planner parameters, and outputs the saved hierarchical planner parameters in response to a readout request.

The knowledge recording medium 60 saves formalized human knowledge (this is called prior knowledge), and outputs the prior knowledge in response to a readout request.

As shown in FIG. 2, in the hierarchical planner optimization device disclosed in Non-Patent Literature 1, the prior knowledge (associated information) saved in the knowledge recording medium 60 is dealt with as a static one and is not updated in hierarchical planner optimization. Therefore, even if the prior knowledge (associated information) is incorrect and/or has omission, it is impossible to improve it. In general, it is often difficult for human being to construct such prior knowledge (associated information) without errors and comprehensively.

### Example Embodiment

An example embodiment of the present invention will hereinafter be described in detail with reference to the drawings.

[Explanation of Configuration]

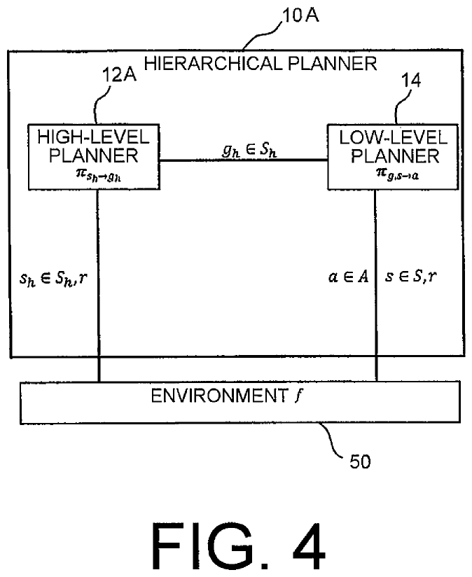

FIG. 4 is a block diagram including a control system including a hierarchical planner according to an example embodiment of the present invention. As shown in FIG. 4, the control system according to the example embodiment comprises a hierarchical planner 10A and the environment 50. The environment 50 is also called a controlled target or a target system.

The hierarchical planner 10A comprises a high-level planner 12A and the low-level planner 14. Since the low-level planner 14 has a structure illustrated in FIG. 3, an explanation thereof is omitted in order to avoid repetition of the explanation.

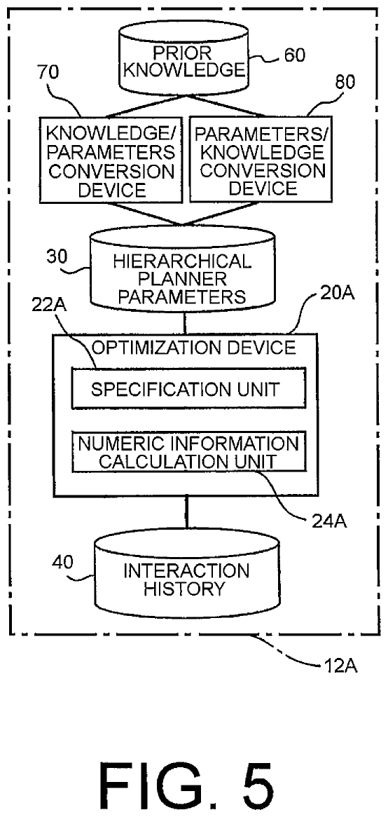

FIG. 5 is a block diagram for illustrating an internal configuration of the high-level planner 12A for use in the hierarchical planner 10A of FIG. 4. The high-level planner 12A is similar in structure and operation to the high-level planner 12 illustrated in FIG. 2 except that the optimization device is modified as will later be described and a knowledge/parameters conversion device 70 and a parameters/knowledge conversion device 80 are further provided. The optimization device is therefore depicted by the reference numeral 20A. Parts similar in functions to those illustrated in FIG. 2 are assigned with the same reference symbols and only differences from the related art will hereafter be described for the purpose of simplification of the explanation.

In the example embodiment (FIG. 5) of the present invention, unlike the related art (FIG. 2), the optimization device 20A in the high-level planner 12A does not directly receive, as an input, the prior knowledge from the knowledge recording medium 60. Instead, the prior knowledge included in the knowledge recording medium 60 is converted through the knowledge/parameters conversion device 70 into optimizable hierarchical planner parameters which are stored in the parameter storage unit 30. Furthermore, optimized hierarchical planner parameters (e.g. weights e) included in the parameter storage unit 30 are stored in the knowledge recording medium 60.

As described above, the prior knowledge is also called the associated information in which two states among the plurality of states related to the environment (target system) 50 are associated with each other. The associated information is associated with, as priority information, numeric information (weight E) related to the associated information (prior knowledge), as described above with reference to FIG. 2. As will later be described, the knowledge/parameters conversion device 70 serves as a selection means configured to select, based on the priority information, a rule (symbol knowledge; associated information) that the numeric information satisfies a first predetermined condition. Herein, the first predetermined condition may be a criterion of employing only a rule that the weight (numeric information) is equal to or more than a threshold (e.g. partial symbol knowledge among the symbol knowledge stored in the knowledge recording medium 60). The present invention is not limited to this criterion, and the selection means may stochastically select a rule at a frequency proportional to the weight of the rule.

The optimization device 20A comprises a specification unit 22A and a numeric information calculation unit 24A.

The specification unit 22A prepares, based on the selected rule (symbol knowledge; associated information), a path including an intermediate state from a certain state to a goal state, and specifies a reward given to a state included in the path. The numeric information calculation unit 24A calculates a value of the above-mentioned weight s in a case where the specified reward and a difference between the above-mentioned numeric information and given numeric information relating to the above-mentioned numeric information satisfy a second predetermined condition. Herein, as the second predetermined condition, for example, an updating expression is supposed which is obtained by applying an optimization method such as the steepest descent or the like to a function weighted with constraint conditions related to the above-mentioned reward and the above-mentioned weight.

On the other hand, as will later be described, the parameters/knowledge conversion device 80 serves as an associated information preparation means configured to select, based on the calculated weight a, the above-mentioned two states from the plurality of states and to prepare the above-mentioned associated information associated with the selected states.

[Explanation of Operation]

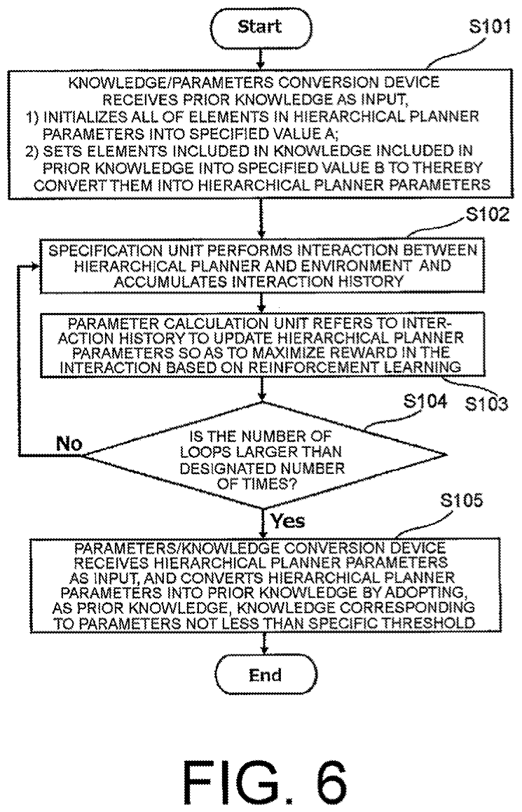

Next, referring to a flow chart of FIG. 6, description will proceed to an operation of the overall control system including the hierarchical planner 10A according to the example embodiment.

First, the knowledge/parameters conversion device 70 receives the prior knowledge from the knowledge recording medium 60 as an input and converts the prior knowledge into hierarchical planner parameters by carrying out processing which will be described in the following (Step S11). At first, the knowledge/parameters conversion device 70 initializes, for example, all of elements in the hierarchical planner parameters (weight s) into a specified value A. Subsequently, the knowledge/parameters conversion device 70 sets the elements included in knowledge included in the prior knowledge into a specified value B. For instance, in an example shown in FIG. 8, for ‘Bottom_of_hills’ and ‘On_left_side_hill’, “−0.2” (specified value B) is set in the hierarchical planner parameters corresponding thereto, respectively. In addition, for the other parameters, “−1.30” (specified value A) is set.

Subsequently, the specification unit 22A of the optimization device 20A carries out interaction between the hierarchical planner 10A and the environment 50 to accumulate interaction history (Step S102). The interaction history is recorded in the history recording medium 40. Herein, as will later be described, the interaction history includes the above-mentioned reward. Thus, as described above, the specification unit 22A serves as a specification means for specifying the reward.

Next, the parameter calculation unit 24A of the optimization device 20A updates the hierarchical planner parameters (e.g. weight c) by referring to the interaction history recorded in the history recording medium 40 and by carrying out processing which will be described in the following (Step S103). Specifically, the parameter calculation unit 24A updates, based on reinforcement learning, the hierarchical planner parameters so as to maximize the reward in the interaction. The updated hierarchical planner parameters are stored in the parameter storage unit 30.

The optimization device 20A repeats these processing (the Steps S102 and S103) a designated number of times (Step S104).

When it is judged that the number of loops is larger than the designated number of times (Yes in the Step S104), the parameters/knowledge conversion device 80 receives the hierarchical planner parameters from the parameter storage unit 30, and converts the hierarchical planner parameters into prior knowledge (associated information) by carrying out processing which will be described in the following (Step S105). Specifically, the parameters/knowledge conversion device 80 adopts, as the prior knowledge, knowledge corresponding to those parameters which are not less than a specific threshold. The converted hierarchical planner parameters are stored in the parameter storage unit 30.

Next, an effect of the example embodiment will be described.

According to the example embodiment, it is possible to carry out improvement of the prior knowledge (associated information) based on optimization of the numeric information.

Each part of the hierarchical planner 10A may be implemented by a combination of hardware and software. In a form in which the hardware and the software are combined, the respective parts are implemented as various kinds of means by developing an associated information improvement program in a RAM (random access memory) and making hardware such as a control unit (CPU (central processing unit)) operate based on the associated information improvement program. The associated information improvement program may be recorded in a recording medium to be distributed. The associated information improvement program recorded in the recording medium is read into a memory via a wire, wirelessly, or via the recording medium itself to operate the control unit and so on. By way of example, the recording medium may be an optical disc, a magnetic disk, a semiconductor memory device, a hard disk, or the like.

Explaining the above-mentioned example embodiment with a different expression, it is possible to implement the example embodiment by making a computer to be operated as the associated information improvement device act as the optimization device 20A, the knowledge/parameters conversion device 70, and the parameters/knowledge conversion device 80 according to the associated information improvement program developed in the RAM.

### Example

Next, description will proceed to an operation of the mode for embodying the present invention using a specific example.

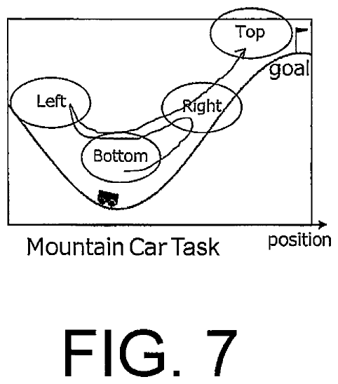

This example supposes a “Mountain Car” task. In the Mountain Car task, a torque is applied to a car to make the car arrive at a goal on a hill, as illustrated in FIG. 7. In this task, the reward r is 100 if the car arrives at the goal, and is −1 otherwise. The state set S includes a velocity of the car and a position of the car. Accordingly, the numeric state information s and the subgoal g belong to the state set S. The action set A includes the torque of the car. The action a belongs to the action set A. The state symbol set Sₕ includes (Bottom_of_hills, On_right_side_hill, On_left_side_hill, At_top_of_right_side_hill). The state symbol sa and the subgoal symbol gₕ belong to the state symbol set S. In this example, [Bottom_of_hills] indicates the starting state. [At_top_of_right_side_hill] indicates the target state (goal state). [On_right_side_hill] and the [On_left_side_hill] indicate the intermediate states. In this example, the environment 50 comprises an operating simulator of the car present in the hill. In addition, in this example, the hierarchical planner 10A plans a way how to apply the torque of the car based on the position and the velocity of the car.

FIG. 8 is a view for illustrating an example of the Step S101 in FIG. 6. The high-level planner 12A in this example is a Strips-style planner based on symbol knowledge. FIG. 8 illustrates an example of the symbol knowledge for the high-level planner 12A, that is recorded in the knowledge recording medium 60 as the prior knowledge. The symbol knowledge (prior knowledge) for the high-level planner 12A illustrated in FIG. 8 is the associated information in which two states among the plurality of states are associated with each other. On the other hand, the low-level planner 14 in this example is implemented by model predictive control. In this example, as the symbol knowledge for the high-level planner 12A, {Bottom_of_hills(x)→On_right_side_hill(x)} and {On_left_side_hill(x)→At_top_of_right_side_hill(x)} are recorded in the knowledge recording medium 60.

In this example, the knowledge/parameters conversion device 70 converts the knowledge included in the prior knowledge into the hierarchical planner parameters corresponding thereto in accordance with the rule, as described above. In this example, the knowledge/parameters conversion device 70 first assumes the specified value A as “−1.30” and initializes all of the elements in the hierarchical planner parameters (weight e). In a table (matrix) shown in FIG. 8, a column direction indicates a state at a certain timing whereas a row direction indicates a state at the next timing. In this example, “−1.30” being the specified value A which is commonly included in a particular column and a particular row represents the priority information (weight e) (upper part in the knowledge, parameters conversion device 70 of FIG. 8).

Thereafter, after carrying out the processing as described above with reference to FIG. 6, updated priority information is calculated (lower part in the knowledge parameters conversion device 70 of FIG. 8). For instance, in an element which is indicated by a row depicted by “On_left_side_hill” and a column depicted by “At_top_of_right_side_hill”, “0.02” is stored as the specified value B. This represents that the hierarchical planner parameters (weight e) are increased by the processing as described above with reference to FIG. 6. That is, this represents an increase in possibility that, in the symbol knowledge (rules), the symbol knowledge of “On_left_side_hill(x)→At_top_of_right_side_hill(x)” is an important rule.

After carrying out the processing as described above with reference to FIG. 6, the updated priority information (weight z) is stored in the parameter storage unit 30 as the hierarchical planner parameters.

In this example, the hierarchical planner parameter (third row and first column) corresponding to “Bottom_of_hills(x)→On_right_side_hill(x)” included in the prior knowledge is set to −0.02 (parameter storage unit 30 in FIG. 8). In addition, the hierarchical planner parameter (second row and fourth column) corresponding to “On_left_side_hill(x)→At_top_of_right_side_hill(x)” is set to −0.02.

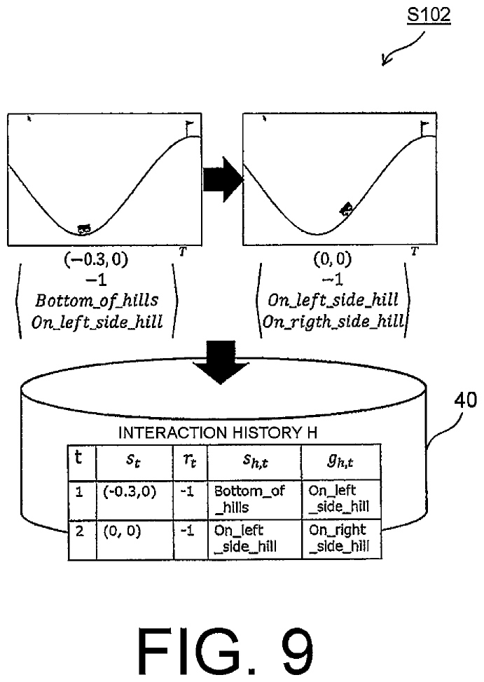

FIG. 9 is a view for illustrating an example of the Step S102 in FIG. 6. As shown in FIG. 9, the specification unit 22A carries out the interaction between the hierarchical planner 10A and the environment 50, and saves it to the history recording medium 40 as the interaction history.

This example supposes the “Mountain Car” task, as described above. In the Mountain Car task, the torque is applied to the car to make the car arrive at the goal on the hill. In this task, the reward r, the state s, the subgoal g, the state symbol sₕ, and the subgoal symbol gₕ are defined as mentioned above. In this example, the environment 50 comprises the operating simulator of the car present in the hill. In addition, in this example, the hierarchical planner 10A plans a way how to apply the torque of the car based on the position and the velocity of the car. In this manner, as shown in FIG. 9, a result of the interaction between the environment 50 and the hierarchical planner 10A is saved per unit time in the history recording medium 40 as the interaction history.

For example, in the example in FIG. 9, “Bottom_of_hills” in the prior knowledge is associated with the numeric state information (−0.3, 0) indicative of a position thereof. In addition, “On_left_side_hill” in the prior knowledge is associated with the numeric state information (0, 0) indicative of a position thereof. The example illustrated in FIG. 9 further represents that, at a time instant 1 (column of t), the prior knowledge (rule) of moving from “Bottom_of_hills” (column of Sₕ) toward “On_left_side_hill” (column of gₕ) is adopted. In addition, the example illustrated in FIG. 9 further represents that, at a time instant 2 (column of t), the prior knowledge (rule) of moving from “On_left_side_hill” (column of S) toward “On_left_side_hill” (column of g_{h,t}) is adopted. These rules represent the prior knowledge (rules) which is selected, in accordance with the processing illustrated in the Step S101 shown in FIG. 6, for example, by determination with respect to the weight.

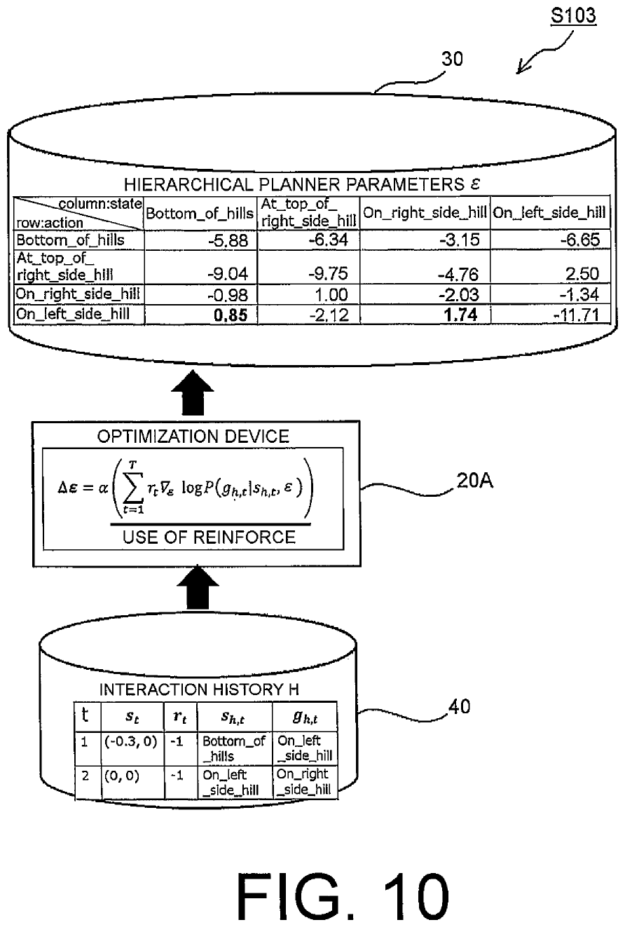

FIG. 10 is a view for illustrating an example of the Step S103 in FIG. 6. This example uses, as the numeric information calculation unit 24A of the optimization device 20A, REINFORCE disclosed in Non-Patent Literature 2 (“use of REINFORCE” in FIG. 10). In this example, the following expression is assumed:

$$P ( {g}_{h , t} \vert {s}_{h , t} , ɛ ) = \frac{{e}^{Q ( {g}_{h , t} , {s}_{h , t} , ɛ )}}{{\sum }_{{g}_{h , t ∈ {s}_{h}}^{′}} Q ( {g}_{h , t}^{′} , {s}_{h , t} , ɛ )} \qquad [ Math . 1 ]$$

where Q represents a value table determined by the hierarchical planner parameters a.

As described above with reference to FIG. 6, the optimization device 20A repeats these processing (the Steps S102 and S103) by the designated number of times (Step S104). Thus, the hierarchical planner parameters, as shown in FIG. 10, are stored in the parameter storage unit 30.

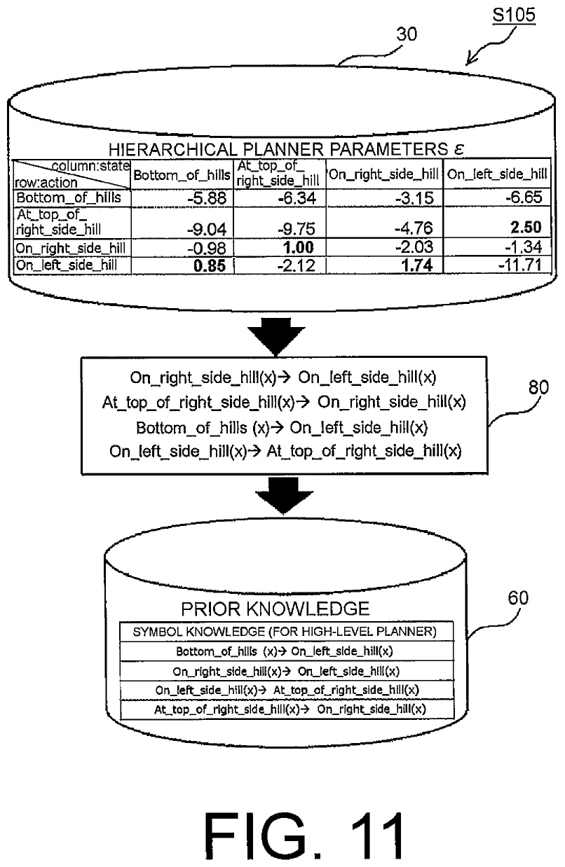

FIG. 11 represents an example of processing for adopting, in the Step S101 in FIG. 6, the prior knowledge (rules) which is adopted based on the weight a.

For instance, referring to a column of “Bottom_of_hills”, a value of “On_left_side_hill” (e.g. a value of the weight s) is equal to 0.85. In a case where 0 is set as the specified value, “Bottom_of_hills(x)→On_left_side_hill(x)” in the prior knowledge is adopted (associated information preparation means 80), and the prior knowledge is stored in the knowledge recording medium 60.

Likewise, for instance, referring to a column of “At_top_of_right_side_hill”, a value of “On_right_side_hill” (e.g. a value of the weight ε) is equal to 1.00. In the case where 0 is set as the specified value, the prior knowledge having a value of 0 or more is adopted. Therefore, “At_top_of_right_side_hill(x)→On_right_side_hill(x)” in the prior knowledge is adopted (associated information preparation means 80), and the prior knowledge is stored in the knowledge recording medium 60.

An effect of this example will be described.

According to this example, it is possible to carry out improvement of the prior knowledge (associated information) based on optimization of the numeric information. In this example, it is possible to acquire, newly as important knowledge, the knowledge of “On_right_side_hill(x)→On_left_side_hill(x)” and “Bottom_of_hills(x)→On_left_side_hill(x)” which have been decided to be unimportant (see FIG. 11).

A specific configuration of the present invention is not limited to the afore-mentioned example embodiment. Alternations without departing from the gist of the present invention are included in the present invention.

While the present invention has been particularly shown and described with reference to the example embodiment (example) thereof, the present invention is not limited to the above-mentioned example embodiment (example). It will be understood by those of ordinary skill in the art that various changes in form and details may be made in the present invention within the scope of the present invention.

### INDUSTRIAL APPLICABILITY

The present invention is applicable to uses such as a plant operation support system. In addition, the present invention is also applicable to uses such as an infrastructure operating support system.

### REFERENCE SIGNS LIST

10A hierarchical planner
12 high-level planner
14 low-level planner
142 second conversion unit
144 control information preparation unit
20A optimization device
22A specification unit
22A numeric information calculation unit
30 parameter storage unit
40 history recording medium
50 environment (target system)
60 knowledge recording medium
70 knowledge/parameters conversion device (selection means)
80 parameters/knowledge conversion device (associated information preparation means)

1. An associated information improvement device, comprising:
a selection unit configured to select, based on priority information in which associated information and numeric information relating to the associated information are associated with each other, associated information associated with the numeric information which satisfies a first predetermined condition, the associated information being information in which two states among a plurality of states related to a target system are associated with each other;
a specification unit configured to prepare a path including an intermediate state from a certain state to a goal state based on the selected associated information and to specify a reward given to a state included in the path; and
a calculation unit configured to calculate the numeric information in a case where the specified reward and a difference between the numeric information and given numeric information relating to the numeric information satisfy a second predetermined condition.

2. The associated information improvement device as claimed in claim 1, further comprising an associated information preparation unit configured to select the two states from the plurality of states based on the numeric information and to prepare the associated information associated with the selected states.

3. The associated information improvement device as claimed in claim 1, further comprising a conversion unit configured to calculate numeric information indicative of the intermediate state based on the states and the associated information.

4. The associated information improvement device as claimed in claim 3, comprising a control information preparation unit configured to prepare control information for controlling the target system based on a difference between the numeric information indicative of the intermediate state and observation information observed with respect to the target system.

5. An associated information improvement method by an information processing device, the method comprising:
selecting, based on priority information in which associated information and numeric information relating to the associated information are associated with each other, associated information associated with the numeric information which satisfies a first predetermined condition, the associated information being information in which two states among a plurality of states related to a target system are associated with each other;
preparing a path including an intermediate state from a certain state to a goal state based on the selected associated information and specifying a reward given to a state included in the path; and
calculating the numeric information in a case where the specified reward and a difference between the numeric information and given numeric information relating to the numeric information satisfy a second predetermined condition.

6. The associated information improvement method as claimed in claim 5, the method comprising:
selecting the two states from the plurality of states based on the numeric information and preparing the associated information associated with the selected states.

7. The associated information improvement method as claimed in claim 5, the method comprising:
calculating numeric information indicative of the intermediate state based on the states and the associated information.

8. The associated information improvement method as claimed in claim 7, the method comprising:
preparing control information for controlling the target system based on a difference between the numeric information indicative of the intermediate state and observation information observed with respect to the target system.

9. A non-transitory recoding medium recording an associated information improvement program causing a computer to execute:
a selection step of selecting, based on priority information in which associated information and numeric information relating to the associated information are associated with each other, associated information associated with the numeric information which satisfies a first predetermined condition, the associated information being information in which two states among a plurality of states related to a target system are associated with each other;
a specification step of preparing a path including an intermediate state from a certain state to a goal state based on the selected associated information and of specifying a reward given to a state included in the path; and
a calculation step of calculating the numeric information in a case where the specified reward and a difference between the numeric information and given numeric information relating to the numeric information satisfy a second predetermined condition.
